(19) United States
(12) Patent Application Publication
(10) Pub. No.: US 2018/0346617 A1
(43) Pub. Date: Dec. 6, 2018

(54) RUBBER COMPOSITION

(71) Applicant: COMPAGNIE GENERALE DES ETABLISSEMENTS MICHELIN, Clermont-Ferrand (FR)

(72) Inventors: Etienne FLEURY, Clermont-Ferrand Cedex 9 (FR); Anne-Frédérique SALIT, Clermont-Ferrand Cedex 9 (FR); Justin BELZ, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/778,795

(22) PCT Filed: Nov. 24, 2016
(86) PCT No.: PCT/FR2016/053069

§ 371 Date: May 24, 2018

(30) Foreign Application Priority Data
Nov. 27, 2015 (FR) 1561451

(51) Int. Cl. C08F 36/06; C08F 36/08; C08L 9/00; C08K 3/08

(52) U.S. Cl. CPC C08F 36/06; C08F 36/08; C08K 2003/0881; C08K 3/08; C08L 9/00

(57) ABSTRACT

The use of a diene elastomer and of a 1,3-dipolar compound in a rubber composition based at least on a reinforcing filler comprising a reinforcing inorganic filler and on a coupling agent is provided. The 1,3-dipolar compound comprises a group Q and a group A connected together by a group B, in which Q comprises a dipole containing at least one nitrogen atom, A comprises an associative group comprising at least one nitrogen atom and B is an atom or a group of atoms forming a bond between Q and A. The diene elastomer is obtained by stereospecific polymerization of at least one 1,3-diene by means of a Ziegler-Natta catalytic system and containing less than 150 ppm of the element neodymium. The use of such a diene elastomer and such a 1,3-dipolar compound in the rubber composition makes it possible to confer a very low hysteresis on the rubber composition.

This application is a 371 national phase entry of PCT/FR2016/053069 filed on 24 Nov. 2016, which claims benefit of French Patent Application No. 1561450, filed 27 Nov. 2015, the entire contents of which are incorporated herein by reference for all purposes.

### BACKGROUND

### 1. Technical Field

The present invention relates to diene rubber compositions which are reinforced by an inorganic filler and which can be used in particular in the manufacture of tires.

### 2. Related Art

In the motor vehicle industry, tires having a low rolling resistance or which do not heat up very much during running are desired. The first performance quality can be desired in order to reduce fuel consumption and the second for increasing the endurance of the tire.

Tires having a low rolling resistance or which do not heat up very much during running can be obtained by virtue of the use of rubber compositions exhibiting low hysteresis.

A rubber composition exhibiting low hysteresis can be obtained in different ways. One of them consists in using, in the rubber composition, coupling agents which make it possible to improve the interaction between the elastomer and the reinforcing filler of the rubber composition. Alternatively, it is possible to use, in the rubber composition, elastomers bearing a functional group which is interactive with respect to the reinforcing filler of the rubber composition.

In particular, it is known, from Patent Applications WO 2012/007442 A1 and WO 2014/090756 A1, to use a 1,3-dipolar compound comprising an associative group in a reinforced diene rubber composition in order to reduce the hysteresis of the rubber composition.

### SUMMARY

The Applicant Companies, which are continuing their efforts, have discovered that the judicious choice of a specific diene elastomer combined with the use of a 1,3-dipolar compound comprising an associative group in a rubber composition reinforced by an inorganic filler makes possible an even more significant reduction in the hysteresis of the rubber composition.

Thus, a subject-matter of the invention is the use of a diene elastomer and of a 1,3-dipolar compound in a rubber composition based at least on a reinforcing filler comprising a reinforcing inorganic filler and on a coupling agent,
the diene elastomer being obtained by stereospecific polymerization of at least one 1,3-diene by means of a Ziegler-Natta catalytic system containing less than 150 ppm of the element neodymium,
the 1,3-dipolar compound comprising a group Q and a group A connected together by a group B, in which Q comprises a dipole containing at least and preferably one nitrogen atom, A comprises an associative group comprising at least one nitrogen atom and B is an atom or a group of atoms forming a bond between Q and A.

### I. DETAILED DESCRIPTION OF EXAMPLE EMBODIMENTS

In the present description, unless expressly indicated otherwise, all the percentages (%) shown are % by weight. The abbreviation “phr” means parts by weight per hundred parts of elastomer (of the total of the elastomers, if several elastomers are present).

Furthermore, any interval of values denoted by the expression “between a and b” represents the range of values greater than “a” and lower than “b” (that is to say, limits a and b excluded), whereas any interval of values denoted by the expression “from a to b” means the range of values extending from “a” up to “b” (that is to say, including the strict limits a and b).

The expression “composition based on” should be understood as meaning, in the present description, a composition comprising the mixture and/or the in situ reaction product of the various constituents used, some of these base constituents (for example the elastomer, the filler or other additive conventionally used in a rubber composition intended for the manufacture of tires) being capable of reacting or intended to react with one another, at least in part, during the various phases of manufacture of the composition intended for the manufacture of tires.

An essential characteristic of embodiments of the invention is the use of a diene elastomer obtained by stereospecific polymerization of at least one 1,3-diene by means of a Ziegler-Natta catalytic system containing less than 150 ppm of the element neodymium.

“Diene” elastomer (or without distinction rubber) should be understood, in a known way, as meaning one (or more) elastomer composed, at least in part (i.e. a homopolymer or a copolymer), of diene monomer units (monomers bearing two conjugated or non-conjugated carbon-carbon double bonds).

For the record, the stereospecific polymerizations are carried out in the presence of a multicomponent catalytic system of Ziegler-Natta type. The catalytic system involves at least three essential organometallic constituents, which are:
a metallic precursor based on a metal belonging to one of Groups III to VIII;
an agent for alkylating the metal of the metallic precursor, which alkylating agent is based on a metal from Group II or III, such as Mg or Al;
a halogenating agent, such as an alkylaluminium halide.

The alkylating agent is also known as cocatalyst.

Some catalytic systems make use of only two constituents, that is to say a metallic precursor based on a transition metal and a cocatalyst, of alkylating agent type.

A person skilled in the art knows the conditions for employing these three constituents in order to obtain catalytic systems effective for the stereospecific polymerization of conjugated diene(s), such as described, for example, in the review “Neodymium Based Ziegler-Natta Catalysts and their Application in Diene Polymerization”, Adv. Polym. Sci. (2006), 204, pp 1-154.

Mention may be made, as metallic precursor, of compounds based on iron, cobalt, nickel, chromium, titanium, vanadium or a rare earth metal, such as neodymium.

Mention may be made, as alkylating agent, of organolithium compounds, alkylaluminium compounds or alkylaluminium hydrides or methylaluminoxanes.

Mention may be made, as halogenating agent, of alkylaluminium halides.

According to the properties of the diene elastomer to be synthesized which are desired, such as its macrostructure and its microstructure, and according to the characteristics of the process which are preferred from the viewpoint of the productive output, a person skilled in the art chooses the constituents of the catalytic system and also their relative proportions in order to obtain a catalytic system which makes possible, under the best conditions, the synthesis of the diene elastomer.

The diene elastomer of use for the requirements of embodiments of the invention has the essential characteristic of being obtained by stereospecific polymerization of a 1,3-diene in the presence of a Ziegler-Natta catalytic system. It also has the essential characteristic of containing less than 150 ppm (parts per million) of neodymium element. In other words, if it contains the element neodymium, whether in the metallic form or in the form of neodymium derivatives, its content is less than 150 ppm in the diene elastomer. A person skilled in the art understands that the diene elastomer of use for the requirements of embodiments of the invention is synthesized in the presence of a catalytic system which does not use a neodymium-based metallic precursor.

According to a particular preferred embodiment, the diene elastomer of use for the requirements of embodiments of the invention is obtained by stereospecific polymerization of a conjugated diene in the presence of a titanium-based Ziegler-Natta catalytic system. The expression “a titanium-based catalytic system” is equivalent to saying that the catalytic system contains a titanium-based metallic precursor. A person skilled in the art understands that the diene elastomer of use for the requirements of embodiments of the invention comprises the element titanium preferably in a content of at least 100 ppm, in particular of 100 to less than 1000 ppm, of titanium element, whether in the metallic form or in the form of titanium derivatives. The presence of the element titanium in the diene elastomer of use for the requirements of embodiments of the invention results from the use of the titanium-based catalytic system in the synthesis of the diene elastomer.

The polymerization in the presence of a titanium-based catalytic system is well known and is documented in the Handbook of Polymer Synthesis, Second Edition, H. Kicheldorf, Oskar Nuyken and Graham Swift, 2004, Technology & Engineering.

Among the titanium-based Ziegler-Natta catalytic systems known for catalyzing diene polymerization, titanium is generally used in the form of a derivative of titanium in the (III) or (IV) oxidation state. Mention may be made, among the Ti(III) or Ti(IV) compounds which are suitable in the catalytic system, of organooxytitanium compounds or titanium halides, in particular titanium tetrachloride.

The titanium-based Ziegler-Natta catalytic system comprises, for example, as cocatalyst, an organoaluminium compound which is preferably chosen from AlR₃ and AlR₂H, where R is chosen from alkyl, cycloalkyl, aryl, alkaryl, aralkyl, cycloalkylalkyl and cycloalkylaryl radicals. Trialkylaluminium compounds or dialkylaluminium compounds are particularly preferred, very particularly when the alkyl radical is a C₂ to C₄ alkyl radical.

The catalytic system, in addition to the titanium derivative and the cocatalyst, can comprise a halogenating agent. Mention may be made, as halogenating agent, of organoaluminium halides, preferably an XAlR′₂, where R′ is chosen from alkyl, cycloalkyl, aryl, alkaryl, aralkyl, cycloalkylalkyl and cycloalkylaryl radicals and X is a halogen atom, preferably an iodine atom.

The polymerization can be carried out according to a continuous or batchwise process, in bulk, in solution or in dispersion. In a polymerization in the presence of solvent, the solvent is generally chosen from aromatic or aliphatic hydrocarbon solvents and their mixtures. Mention may be made, as solvent commonly used, of toluene, pentane, hexane, heptane, cyclohexane and methylcyclohexane.

The monomer polymerized in order to result in the diene elastomer of use for the requirements of embodiments of the invention is a diene, preferably a 1,3-diene having from 4 to 8 carbon atoms, more preferably butadiene, isoprene or their mixture.

The relative amounts of monomer, of titanium derivatives, of cocatalyst and, if appropriate, of halogenating agent and of solvent for the manufacture of the diene elastomer of use for the requirements of embodiments of the invention are determined by a person skilled in the art as a function of the characteristics desired for the diene elastomer, such as the microstructure and the macrostructure, and as a function of desired processing parameters, such as the kinetics or the yield.

The diene elastomer of use for the requirements of embodiments of the invention can be synthesized according to any one of the abovementioned alternative forms of polymerization catalysed by a titanium-based Ziegler-Natta catalytic system. The diene elastomer of use for the requirements of embodiments of the invention can be a mixture of diene elastomers which differ from one another in their microstructure or their macrostructure.

According to one embodiment of the invention, the diene elastomer of use for the requirements of the invention contains more than 90 mol % of cis-1,4-bonds.

According to a specific embodiment of the invention, the diene elastomer of use for the requirements of the invention is a polyisoprene, preferably a “high cis content” polyisoprene, that is to say a polyisoprene exhibiting more than 90 mol % of cis-1,4-bonds. For example, commercial polyisoprenes, such as Nipol 2200 from Nippon Zeon, are suitable.

An essential characteristic of embodiments of the invention is the use of a 1,3-dipolar compound.

The 1,3-dipolar compound comprises a (one or more) group Q and a (one or more) group A connected together by a group B, in which:
Q comprises a dipole containing at least and preferably one nitrogen atom,
A comprises an associative group comprising at least one nitrogen atom,
B is an atom or a group of atoms forming a bond between Q and A.

According to any one of the embodiments of the invention, the 1,3-dipolar compound preferably contains just one group Q connected to the group(s) A by the group B.

According to any one of the embodiments of the invention, the 1,3-dipolar compound more preferably contains just one group Q and just one group A connected together by the group B.

Dipole is understood to mean a functional group capable of forming a [1,3]-dipolar cycloaddition on an unsaturated carbon-carbon bond.

“Associative group” is understood to mean groups capable of associating with one another via hydrogen bonds, each associative group comprising at least one donor “site” and one site which is accepting with regard to the hydrogen bond, so that two identical associative groups are self-complementary and can associate together with the formation of at least two hydrogen bonds.

According to a specific embodiment of the invention, the group A is selected from the group consisting of the imidazolidinyl, triazolyl, triazinyl, bis-ureyl and ureido-pyrimidyl groups.

According to a preferred embodiment of the invention, the group A corresponds to one of the following formulae (I) to (V):

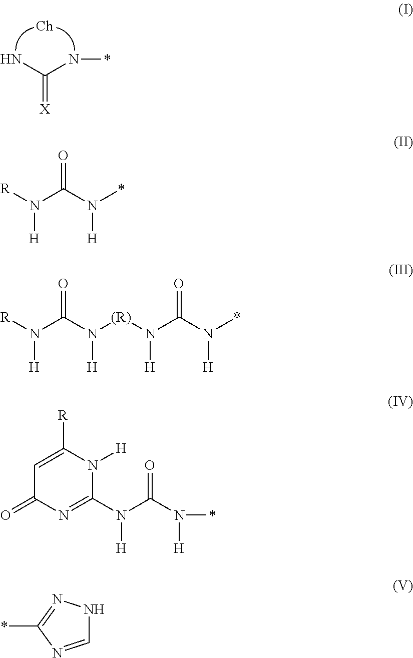

where:
Ch denotes a carbon chain which can optionally contain heteroatoms,
* represents a direct attachment to B,
R denotes a hydrocarbon group which can optionally contain heteroatoms,
X denotes an oxygen or sulfur atom or an NH group, preferably an oxygen atom.

Generally, the ring in the formula (I) is a ring comprising 5 or 6 atoms.

According to a more preferred embodiment of the invention, the group A corresponds to the formula (VI) where * represents a direct attachment to B.

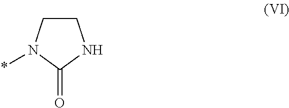 [SMILES: *N1CCNC1=O]

The group B, which is an atom or a group of atoms forming a bond between Q and A, is preferably a group containing up to 20 carbon atoms which can contain at least one heteroatom. B can be an aliphatic chain preferably containing from 1 to 20 carbon atoms, more preferably from 1 to 12 carbon atoms and more preferably still from 1 to 6 carbon atoms, or a group containing an aromatic unit and preferably containing from 6 to 20 carbon atoms, more preferably from 6 to 12 carbon atoms.

According to a preferred embodiment of the invention, the 1,3-dipolar compound is selected from the group consisting of nitrile oxides, nitrones and nitrile imines, in which case Q contains a —C≡N→O, —C═N(→O)— or —C≡N→N unit.

According to the specific embodiment of the invention where Q comprises a —C≡N→O unit, Q preferably denotes the unit corresponding to the formula (VII) in which four of the five symbols R₄ to R₈, which are identical or different, are each an atom, in particular H, or a group of atoms and the fifth symbol denotes a direct attachment to B, it being known that R₄ and R₈ are preferably both other than H. The group of atoms is preferably an aliphatic group or a group containing an (one or more) aromatic unit. The aliphatic group can contain from 1 to 20 carbon atoms, preferably from 1 to 12 carbon atoms, more preferably from 1 to 6 carbon atoms and more preferably still from 1 to 3 carbon atoms. The group containing an (one or more) aromatic unit can contain from 6 to 20 carbon atoms, preferably from 6 to 12 carbon atoms.

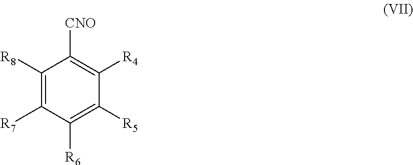

R₄, R₆ and R₈ are preferably each an alkyl group of 1 to 6 carbon atoms, more preferably of 1 to 3 carbon atoms and more preferably still a methyl or ethyl group.

According to an alternative form of this specific embodiment of the invention, R₄, R₆ and R₈ are identical. According to this alternative form where they are identical, R₄, R₆ and R₈ are preferably each an alkyl group of 1 to 6 carbon atoms, more preferably of 1 to 3 carbon atoms and more preferably still a methyl or ethyl group.

According to another alternative form of this specific embodiment of the invention according to which Q denotes the unit of formula (VII) and B represents a unit chosen from —(CH₂)_{y1}—, —[NH—(CH₂)_{y2}]ₓ₁— and —[O—(CH₂)_{y3}]ₓ₂—, y₁, y₂ and y₃ independently representing an integer ranging from 1 to 6, and x₁ and x₂ independently representing an integer ranging from 1 to 4. This alternative form can be combined with the alternative form according to which R₄, R₆ and R₈ are identical, preferably each an alkyl group of 1 to 6 carbon atoms, more preferably of 1 to 3 carbon atoms and more preferably still a methyl or ethyl group.

The 1,3-dipolar compound is advantageously one of the compounds of formulae (VIII) to (XIII):

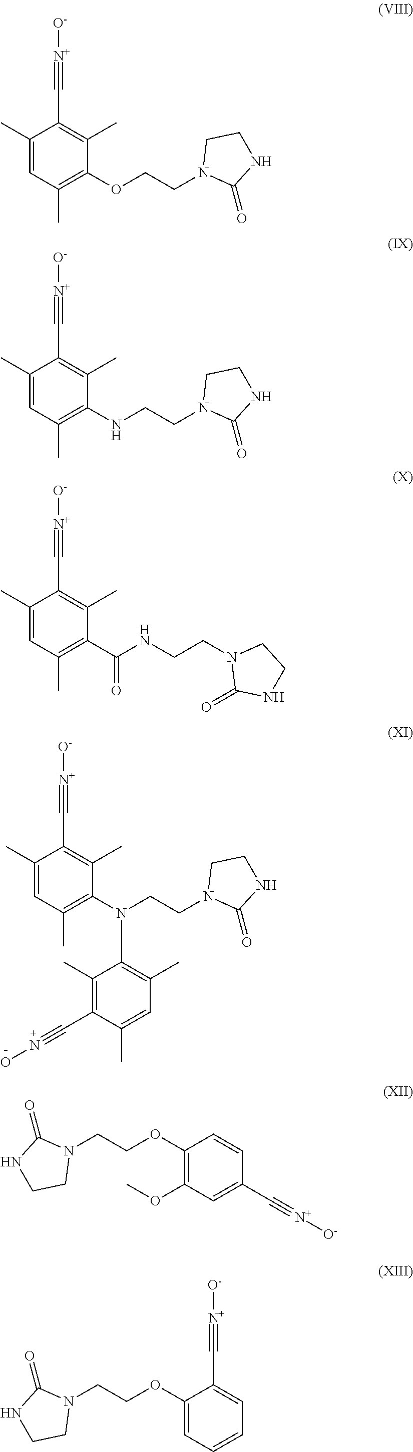

More preferably, the 1,3-dipolar compound is the compound of formula (VIII), 2,4,6-trimethyl-3-(2-(2-oxoimidazolidin-1-yl)ethoxy)benzonitrile oxide.

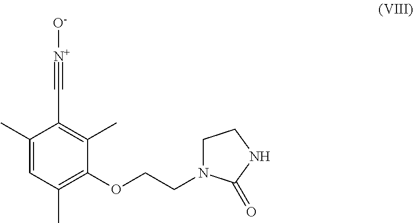 [SMILES: Cc1cc(C)c(OCCN2CCNC2=O)c(C)c1C#[N+][O-]]

According to the specific embodiment of the invention where Q comprises a —C═N(→O)— unit, Q preferably comprises the unit corresponding to the formula (XIV) or (XV):

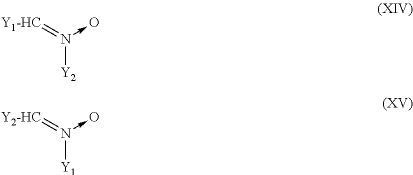

where:
Y₁ is an aliphatic group, preferentially an alkyl group preferably containing from 1 to 12 carbon atoms, or a group containing from 6 to 20 carbon atoms and comprising an aromatic unit, preferably an aryl or alkylaryl group, more preferably a phenyl or tolyl group,
and Y₂ is an aliphatic group, preferentially a saturated hydrocarbon group preferably containing from 1 to 12 carbon atoms, or a group comprising an aromatic unit and preferably containing from 6 to 20 carbon atoms, Y₂ comprising a direct attachment to B.

According to this specific embodiment of the invention, the 1,3-dipolar compound is one of the 1,3-dipolar compounds of formulae (XVI) to (XX):

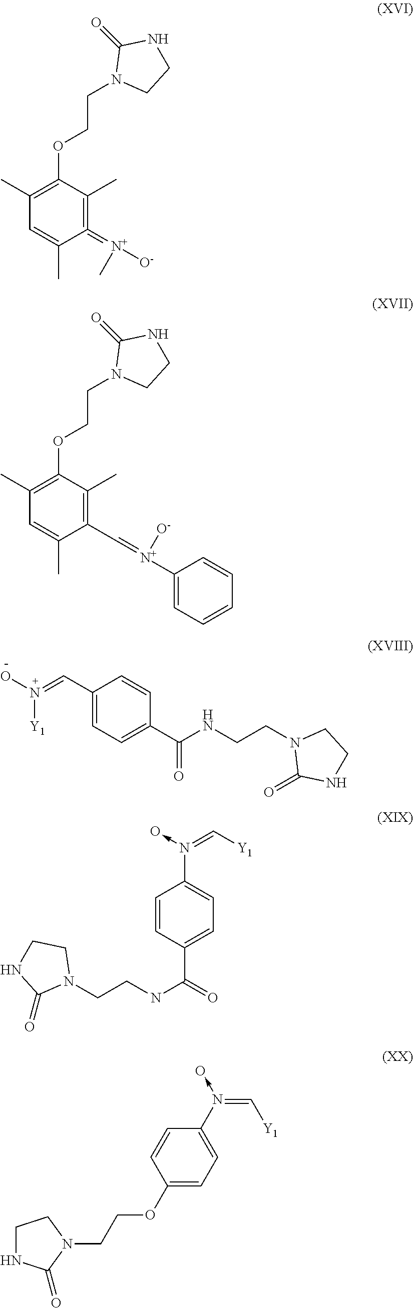

with Y₁ being as defined above, namely an aliphatic group, preferentially an alkyl group preferably containing from 1 to 12 carbon atoms, or a group containing from 6 to 20 carbon atoms and comprising an aromatic unit, preferably an aryl or alkylaryl group, more preferably a phenyl or tolyl group.

The content of 1,3-dipolar compound used is expressed as molar equivalent of group A. For example, if the 1,3-dipolar compound contains just one group A, such as, for example, in the compound of formula (VIII), one mole of group A corresponds to one mole of 1,3-dipolar compound. If the 1,3-dipolar compound contains two rings of group A, two moles of group A correspond to one mole of 1,3-dipolar compound. In the latter case, the use of the 1,3-dipolar compound according to one molar equivalent of group A corresponds to half a mole of 1,3-dipolar compound.

According to any one of the embodiments of the invention, the amount of 1,3-dipolar compound used is preferably from 0.01 to 50, more preferably from 0.01 to 10, more preferably still from 0.03 to 5 and better still from 0.03 to 3 molar equivalents of group A per 100 mol of monomer units constituting the diene elastomer of use for the requirements of the invention. The preferred ranges can apply to any one of the embodiments of the invention.

According to a specific embodiment of the invention, the 1,3-dipolar compound is pregrafted to the diene elastomer of use for the requirements of the invention. In other words, the diene elastomer of use for the requirements of embodiments of the invention can be modified by grafting of the 1,3-dipolar compound before it is introduced into the rubber composition.

According to this specific embodiment of the invention, the diene elastomer of use for the requirements of the invention is modified post-polymerization by grafting of the 1,3-dipolar compound. The grafting of the 1,3-dipolar compound is carried out by [3+2]-cycloaddition of the reactive group or groups of the 1,3-dipolar compound to one or more double bonds of the chains of the diene elastomer. The mechanism of the cycloaddition of a nitrile oxide, of a nitrone and of a nitrile imine can be illustrated by the following equations, in which the symbol ¤ represents any substituent:
Cycloaddition of an nitrile oxide to an unsaturation or double bond of a diene elastomer (in this instance, a polyisoprene)

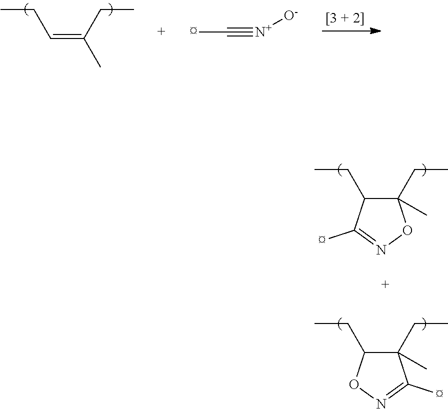

Cycloaddition of a nitrone to an unsaturation or double bond of a diene elastomer (in this instance, a polyisoprene)

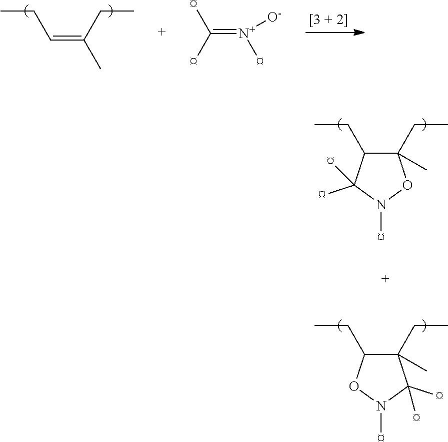

Cycloaddition of a nitrile imine to an unsaturation or double bond of a diene elastomer (in this instance, a polyisoprene)

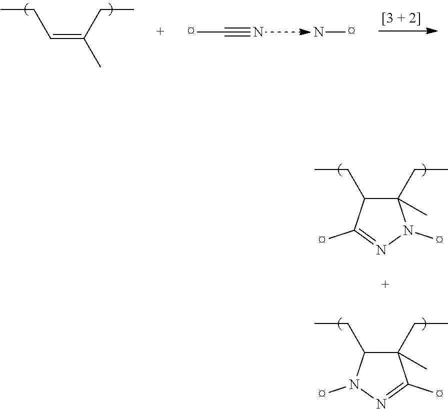

The grafting of the 1,3-dipolar compound to the diene elastomer of use for the requirements of embodiments of the invention can be carried out in bulk or in solution, preferably in bulk.

The grafting in bulk of the 1,3-dipolar compound to the diene elastomer of use for the requirements of embodiments of the invention can be carried out in an internal mixer or an external mixer, such as an open mill. The grafting is then carried out either at a temperature of the external mixer or of the internal mixer of less than 60° C., followed by a stage of grafting reaction under a press or in an oven at temperatures ranging from 80° C. to 200° C., or at a temperature of the external mixer or of the internal mixer of greater than 60° C., without subsequent heat treatment. When the grafting is carried out in bulk, it is preferably carried out in the presence of an antioxidant.

The grafting in solution of the 1,3-dipolar compound to the diene elastomer of use for the requirements of embodiments of the invention can be carried out continuously or batchwise, after the synthesis of the diene elastomer by titanium-based Ziegler-Natta polymerization. The diene elastomer thus grafted can be separated from its solution by any type of means known to a person skilled in the art and in particular by a steam stripping operation.

The rubber composition in which the diene elastomer of use for the requirements of embodiments of the invention and the 1,3-dipolar compound are used contains a reinforcing filler and a coupling agent, which reinforcing filler comprises a reinforcing inorganic filler.

The reinforcing filler is any type of “reinforcing” filler known for its abilities to reinforce a rubber composition which can be used for the manufacture of tires, for example an organic filler, such as carbon black, a reinforcing inorganic filler, such as silica, with which is combined, in a known way, a coupling agent, or also a mixture of these two types of fillers.

Such a reinforcing filler typically consists of nanoparticles, the (weight-)average size of which is less than a micrometre, generally less than 500 nm, most commonly between 20 and 200 nm, in particular and more preferably between 20 and 150 nm.

All carbon blacks, in particular the blacks conventionally used in tires or their treads (“tire-grade” blacks), are suitable as carbon blacks. Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 and N772 blacks. These carbon blacks can be used in the isolated state, as commercially available, or in any other form, for example as support for some of the rubber additives used.

“Reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of pneumatic tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferably silica (SiO₂), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g, in particular between 60 and 300 m²/g. Mention will be made, as highly dispersible precipitated silicas (“HDSs”), for example, of the Ultrasil 7000 and Ultrasil 7005 silicas from Evonik-Degussa, the Zeosil 1165MP, 1135MP, 1115MP and Premium 200MP silicas from Rhodia, the Hi-Sil EZ150G silica from PPG, the Zeopol 8715, 8745 and 8755 silicas from Huber or the silicas with a high specific surface as described in Application WO 03/016387.

In the present account, the BET specific surface is determined in a known way by gas adsorption using the Brunauer-Emmett-Teller method described in The Journal of the American Chemical Society, Vol. 60, page 309, February 1938, more specifically, according to French Standard NF ISO 9277 of December 1996 (multipoint (5 point) volumetric method—gas: nitrogen—degassing: 1 hour at 160° C.—relative pressure p/po range: 0.05 to 0.17). The CTAB specific surface is the external surface determined according to French Standard NF T 45-007 of November 1987 (method B).

The physical state under which the reinforcing inorganic filler is provided is not important, whether in the form of a powder, of microbeads, of granules or else of beads. Of course, reinforcing inorganic filler is also understood to mean mixtures of different reinforcing inorganic fillers, in particular of highly dispersible silicas as described above.

A person skilled in the art will understand that use might be made, as filler equivalent to the reinforcing inorganic filler described in the present section, of a reinforcing filler of another nature, in particular organic nature, such as carbon black, provided that this reinforcing filler is covered with an inorganic layer, such as silica, or else comprises, at its surface, functional sites, in particular hydroxyl sites, requiring the use of a coupling agent in order to establish the bond between the filler and the elastomer. Mention may be made, by way of example, of, for example, carbon blacks for tires, such as described, for example, in patent documents WO 96/37547 and WO 99/28380.

According to a specific embodiment of the invention, the inorganic filler, preferably a silica, represents more than 50% by weight of the reinforcing filler of the rubber composition. It is then said that the reinforcing inorganic filler is predominant.

When it is combined with a predominant reinforcing inorganic filler, such as silica, the carbon black is preferably used at a content of less than 20 phr, more preferably of less than 10 phr (for example, between 0.5 and 20 phr, in particular between 2 and 10 phr). Within the intervals indicated, the colouring properties (black pigmenting agent) and UV-stabilizing properties of the carbon blacks are beneficial, without, moreover, adversely affecting the typical performance qualities contributed by the reinforcing inorganic filler.

The content of total reinforcing filler is preferably between 20 and 200 phr. Below 20 phr, the reinforcement of the rubber composition may be insufficient to contribute an appropriate level of cohesion or wear resistance of the rubber component of the tire comprising this composition. Above 200 phr, there is a risk of increasing the hysteresis and thus the rolling resistance of the tires. For this reason, the content of total reinforcing filler is more preferably between 30 and 150 phr, more preferably still from 50 to 150 phr, in particular for use in a tire tread. Any one of these ranges of content of total reinforcing filler can apply to any one of the embodiments of the invention.

In order to couple the reinforcing inorganic filler to the diene elastomer of use for the requirements of embodiments of the invention, use is made, in a well-known way, of an at least bifunctional coupling agent, in particular a silane, (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional.

Use is made in particular of silane polysulfides, referred to as “symmetrical” or “asymmetrical” depending on their specific structure, such as described, for example, in Applications WO 03/002648 (or US 2005/016651) and WO 03/002649 (or US 2005/016650).

Suitable in particular, without the definition below being limiting, are silane polysulfides corresponding to the following general formula (V):

Z-G-Sₓ-G-Z
in which:
   x is an integer from 2 to 8 (preferably from 2 to 5);
   the G symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
   the Z symbols, which are identical or different, correspond to one of the three formulae below:

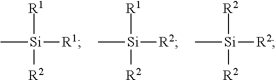

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
   the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

In the case of a mixture of alkoxysilane polysulfides corresponding to the above formula, in particular normal commercially available mixtures, the mean value of the “x” indices is a fractional number preferably of between 2 and 5, more preferably of approximately 4. However, embodiments of the invention can also advantageously be carried out, for example, with alkoxysilane disulfides (x=2).

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Use is made in particular, among these compounds, of bis(3-triethoxysilylpropyl) tetrasulfide, abbreviated to TESPT, of formula [(C₂H₅O)₃Si(CH₂)₃S₂]₂, or bis(3-triethoxysilylpropyl) disulfide, abbreviated to TESPD, of formula [(C₂H₅O)₃Si(CH₂)₃S]₂.

Mention will in particular be made, as coupling agent other than alkoxysilane polysulfide, of bifunctional POSs (polyorganosiloxanes), or else of hydroxysilane polysulfides, such as described in Patent Applications WO 02/30939 (or U.S. Pat. No. 6,774,255) and WO 02/31041 (or US 2004/051210), or else of silanes or POSs bearing azodicarbonyl functional groups, such as described, for example, in Patent Applications WO 2006/125532, WO 2006/125533 and WO 2006/125534.

According to any one of the embodiments of the invention, the coupling agent can be one of the silanes mentioned.

The content of coupling agent is advantageously less than 30 phr, it being understood that it is generally desirable to use as little as possible of it. Typically, the content of coupling agent represents from 0.5% to 15% by weight, with respect to the amount of inorganic filler. Its content is preferably between 0.5 and 16 phr, more preferably within a range extending from 3 to 10 phr. This content is easily adjusted by a person skilled in the art depending on the content of inorganic filler used in the composition.

The rubber composition can also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state.

According to any one of the embodiments of the invention, the rubber composition can additionally contain a chemical crosslinking agent. The chemical crosslinking makes possible the formation of covalent bonds between the elastomer chains. The chemical crosslinking agent can be a vulcanization system or one or more peroxide compounds.

According to a first alternative form, the vulcanization system proper is based on sulfur (or on a sulfur-donating agent) and on a primary vulcanization accelerator. Additional to this base vulcanization system are various known secondary vulcanization accelerators or vulcanization activators, such as zinc oxide, stearic acid or equivalent compounds, or guanidine derivatives (in particular diphenylguanidine), incorporated during the first non-productive phase and/or during the productive phase, as described subsequently. The sulfur is used at a preferred content of 0.5 to 12 phr, in particular of 1 to 10 phr. The primary vulcanization accelerator is used at a preferred content of between 0.5 and 10 phr, more preferably of between 0.5 and 5 phr. These preferred ranges can apply to any one of the embodiments of the first alternative form of the invention. Use may be made, as (primary or secondary) accelerator, of any compound capable of acting as accelerator of the vulcanization of diene elastomers in the presence of sulfur, in particular accelerators of the thiazole type and their derivatives, and accelerators of thiuram and zinc dithiocarbamate types. Preferably, use is made of a primary accelerator of the sulfenamide type.

According to a second alternative form, when the chemical crosslinking is carried out using one or more peroxide compounds, the said peroxide compound(s) represent from 0.01 to 10 phr. Mention may be made, as peroxide compounds which can be used as chemical crosslinking system, of acyl peroxides, for example benzoyl peroxide or p-chlorobenzoyl peroxide, ketone peroxides, for example methyl ethyl ketone peroxide, peroxyesters, for example t-butyl peroxyacetate, t-butyl peroxybenzoate and t-butyl peroxyphthalate, alkyl peroxides, for example dicumyl peroxide, di(t-butyl) peroxybenzoate and 1,3-bis(t-butylperoxyisopropyl)benzene, or hydroperoxides, for example t-butyl hydroperoxide.

The rubber composition can also comprise all or a portion of the usual additives generally used in the elastomer compositions intended to constitute external mixtures of finished rubber articles, such as tires, in particular treads, such as, for example, plasticizers or extending oils, whether the latter are aromatic or non-aromatic in nature, in particular very weakly aromatic or non-aromatic oils (e.g., paraffin oils, hydrogenated naphthenic oils, MES oils or TDAE oils), vegetable oils, in particular glycerol esters, such as glycerol trioleates, pigments, protective agents, such as antiozone waxes, chemical antiozonants or antioxidants, anti-fatigue agents, reinforcing resins (such as resorcinol or bismaleimide), methylene acceptors (for example phenolic novolak resin) or methylene donors (for example HMT or H3M), such as described, for example, in Application WO 02/10269.

The rubber composition can additionally contain a second diene elastomer other than the diene elastomer of use for the requirements of embodiments of the invention.

The second diene elastomer is a diene elastomer conventional in the field of tires, such as the elastomers chosen from polybutadienes (BRs), synthetic polyisoprenes (IRs), natural rubber (NR), butadiene copolymers, isoprene copolymers and the mixtures of these elastomers.

It should be noted that the improvement in the properties of the rubber composition will be greater as a proportion of the second diene elastomer in the rubber composition becomes smaller. This is why the diene elastomer of use for the requirements of embodiments of the invention, in or not in pregrafted form, is present in the rubber composition preferably according to an amount of greater than 50 phr, more preferably of greater than 75 phr and more preferably still of greater than 90 phr. These preferred ranges can apply to any one of the embodiments of the invention.

The rubber composition can be manufactured in appropriate mixers, using two successive phases of preparation according to a general procedure well known to a person skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the chemical crosslinking agent, in particular the vulcanization system, is incorporated.

Generally, all the base constituents of the composition included in the tire of embodiments of the invention, with the exception of the chemical crosslinking agent, are intimately mixed by thermomechanical kneading, in one or more stages, until the maximum temperature of between 130° C. and 200° C., preferably of between 145° C. and 185° C., is reached.

By way of example, the first (non-productive) phase is carried out in a single thermomechanical stage during which all the necessary constituents, the optional additional processing aids and various other additives, with the exception of the chemical crosslinking agent, are introduced into an appropriate mixer, such as a normal internal mixer. The total duration of the kneading, in this non-productive phase, is preferably between 1 and 15 min. After cooling the mixture thus obtained during the first non-productive phase, the chemical crosslinking agent is then incorporated at low temperature, generally in an external mixer, such as an open mill; everything is then mixed (productive phase) for a few minutes, for example between 2 and 15 min.

In the specific case where the 1,3-dipolar compound is pregrafted to the diene elastomer of use for the requirements of embodiments of the invention, it is the diene elastomer in its grafted form which is introduced into the appropriate mixers. In the other cases, the diene elastomer of use for the requirements of embodiments of the invention and the 1,3-dipolar compound are introduced as such as base constituents into the appropriate mixers. In these other cases, the 1,3-dipolar compound is preferably thermomechanically kneaded with the diene elastomer of use for the requirements of embodiments of the invention before introducing the other base constituents of the rubber composition.

The final composition thus obtained is subsequently calendered, for example in the form of a sheet or of a plaque, in particular for laboratory characterization, or else extruded in the form of a rubber profiled element which can be used as semi-finished tire product for a vehicle.

The rubber composition, which can be either in the raw state (before crosslinking or vulcanization) or in the cured state (after crosslinking or vulcanization), can be a semi-finished product which can be used in a tire, in particular as a tire tread.

The abovementioned characteristics of the present invention, and also others, will be better understood on reading the following description of several exemplary embodiments of the invention, given by way of illustration and without limitation.

### II. EXEMPLARY EMBODIMENTS

### II.1—Measurements and Tests Used:

### II.1.1—Measurement of the Content of Neodymium or Titanium Derivatives:

Any diene elastomer synthesized in the presence of a catalytic system comprising a metallic precursor may contain the metallic element in the metal form or in the form of derivatives of this metal. In order to quantify the content of the metallic element in the elastomer, whether in the form of metal or of metallic derivatives, use is made of an indirect method which involves the mineralization of a sample of the elastomer and involves inductively coupled plasma atomic emission spectroscopy. This method makes it possible to determine the nature and the content by weight of the metallic element present in the mineralized sample. This measured content is also the content by weight of the metallic element in the sample of non-mineralized elastomer. The content by weight of the metallic element, whether in the form of metal or of metallic derivatives, in the elastomer is thus expressed as parts per million (ppm) of the element neodymium. Thus, 100 ppm of element Nd in the non-mineralized elastomer corresponds to a content of 100 ppm of element Nd measured in the mineralized elastomer sample.

The method is described in detail below:

Inductively coupled plasma atomic emission spectroscopy (ICP-AES) is a technique which makes it possible to carry out both a qualitative and quantitative elemental analysis.

The determination of the content of catalytic residues by ICP-AES is broken down into two stages: the mineralization of the sample (dissolution of the elements of the sample) and the analysis of the solution obtained by ICP-AES.

The mineralization of the sample consists of an acid digestion assisted by microwaves. A withdrawn sample of several tens of mg is cut into small pieces and placed in a microwave reactor with a mixture of concentrated nitric and hydrochloric acids (the nitric acid must be in excess and the composition of the mixture can vary from 60/40 to 90/10% v:v). The reactor is closed and placed in a microwave oven, where it is subjected to a mineralization programme: the microwaves rotate the polar molecules, resulting in heating by molecular friction and release of heat at the core of the body. Under the effect of the temperature and of the pressure (temperature gradient up to 220° C. and maximum pressure of 75 bar, depending on the temperature), the material becomes oxidized and the elements pass into solution. The solution is subsequently quantitatively decanted into a volumetric flask of known volume and then analysed by ICP-AES.

The ICP-AES technique (gas: argon; power of the plasma: 1100 W; emission wavelengths λTi=334.941 nm and λ_{Nd}=401.225 nm) uses a plasma to desolvate, vaporize, atomize (sometimes ionize) and excite the elements of the sample solution. When the excited atoms or ions return to their ground state, they emit a wavelength characteristic of the element, the intensity of which is proportional to the concentration of the element in the solution. By comparing the intensities of the emission lines of the elements Ti and Nd with an external calibration range, the concentrations of these elements in the sample can be determined.

### II.1.2—Microstructure of the Elastomers:

The microstructure is determined according to the method described in the paper entitled “Fast and robust method for the determination of microstructure and composition in butadiene, styrene-butadiene, and isoprene rubber by near-infrared spectroscopy”, Vilmin F., Dussap C. and Coste N., Appl. Spectrosc., 2006, 60(6), 619-30.

### II.1.3—Mooney Plasticity:

In order to measure the Mooney plasticity, use is made of an oscillating consistometer as described in French Standard NF T 43-005 (1991). The Mooney plasticity measurement is carried out according to the following principle: the composition in the raw state (i.e., before curing) is moulded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney unit” (MU, with 1 MU=0.83 newton·metre).

### II.1.4—Dynamic Properties:

The dynamic properties are measured on a viscosity analyser (Metravib VA4000) according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (23° C.) and at 60° C., according to Standard ASTM D 1349-99, is recorded. A strain amplitude sweep is carried out from 0.1% to 100% (outward cycle) and then from 100% to 0.1% (return cycle). The results made use of are the loss factor tan(δ) at 23° C. and at 60° C. For the return cycle, the maximum value of tan(δ) observed, denoted tan(δ) max, is indicated. The results are recorded in base 100 with respect to a reference. The lower the value, the lower the value of tan(δ) max, the better the gain in hysteresis.

### II.2—Preparation of the Rubber Compositions:

The elastomers IR-Ti and IR—Nd are used in the preparation of the rubber compositions C1 and C2.

IR—Ti is a commercial polyisoprene, Nipol 2200 from Nippon Zeon, which polyisoprene is prepared by Ziegler-Natta polymerization in the presence of a Ti-based catalytic system.

IR—Nd is a polyisoprene prepared by Ziegler-Natta polymerization in the presence of a neodymium-based catalytic system, such as described in Application WO 2014086804. It contains more than 150 ppm of the element Nd.

The 1,3-dipolar compound used is 2,4,6-trimethyl-3-(2-(2-oxoimidazolidin-1-yl)ethoxy)benzonitrile oxide, the synthesis of which is described in Patent Application WO 2012007442.

The formulations (in phr) of the compositions C1, C1-R, C2 and C2-R are described in Table 1. Only C1 is a composition which corresponds to a use in accordance with embodiments of the invention since it results from the use of the 1,3-dipolar compound and of IR-Ti.

The composition C1-R differs from the composition C1 in that it is devoid of 1,3-dipolar compound. The composition C2 differs from C1 in the origin of the elastomer, since IR-Nd is used in C2. The composition C2-R is a composition which is devoid of 1,3-dipolar compound and which contains IR-Nd.

The rubber compositions are prepared in the following way:
the diene elastomer and, if appropriate, the 1,3-dipolar compound are introduced into an 85-cm³ Polylab internal mixer, 70% filled, the initial vessel temperature of which is approximately 50° C.,
thermomechanical working is carried out at 110° C. for 1 to 2 min,
the reinforcing filler, the coupling agent and the various other ingredients, with the exception of the vulcanization system, are then introduced,
thermomechanical working is then carried out (non-productive phase) in one stage (total duration of the kneading equal to approximately 5 min), until a maximum “dropping” temperature of 160° C. is reached,
the mixture thus obtained is recovered and cooled and then the vulcanization system (sulfur and accelerator) is added on an external mixer (homofinisher) at 25° C., everything being mixed (productive phase) for approximately 5 to 6 min.

### II.3—Properties of the Rubber Compositions in the Cured State:

The compositions after vulcanization are calendered, either in the form of plaques (with a thickness ranging from 2 to 3 mm) or thin sheets of rubber, for the measurement of their physical or mechanical properties, or in the form of profiled elements which can be used directly, after cutting and/or assembling to the desired dimensions, for example as semi-finished products for tires, in particular for treads. The results are recorded in Table 2.

C1-R and C2-R are reference compositions for evaluating the gain in hysteresis by the combined use of the 1,3-dipolar compound and, respectively, of IR and of IR-Nd. Consequently, the tan(δ) max values for C1-R and C2-R are equal to 100 and are to be compared with the respective tan(δ) max values for C1 and C2.

It is observed that C1 exhibits tan(δ) max values at 23° C. and 60° C. which are respectively 55 and 59, against only 67 and 75 for C2. These values show that the fall in the tan(δ) max value at 23′C and 60′C is much greater when an IR-Ti rather than an IR-Nd is used in combination with the 1,3-dipolar compound.

These unexpected results convey that the greatest gain in hysteresis is obtained when use is made, in the rubber composition, jointly of the 1,3-dipolar compound and of a diene elastomer synthesized by a Ziegler-Natta polymerization in the presence of a titanium-based catalytic system.

TABLE 1

| | C1 | C1-R | C2 | C2-R |
|---|---|---|---|---|
| Composition | inventive | reference | non-inventive | reference |
| IR-Ti elastomer (1) | 100 | 100 | | |
| IR-Nd elastomer (2) | — | — | 100 | 100 |
| Carbon black (3) | 3 | 3 | 3 | 3 |
| Silica (4) | 50 | 50 | 50 | 50 |
| Silane (5) | 5 | 5 | 5 | 5 |
| 1,3-Dipolar | 2.1 | — | 2.1 | — |
| compound (6) | | | | |
| Antiozone wax | 1 | 1 | 1 | 1 |
| Antioxidant | 2.5 | 2.5 | 2.5 | 2.5 |
| Stearic acid | 2.5 | 2.5 | 2.5 | 2.5 |
| ZnO | 2.7 | 2.7 | 2.7 | 2.7 |
| Sulfur | 1.5 | 1.5 | 1.5 | |
| Accelerator (7) | 1.8 | 1.8 | 1.8 | |

(1) Nipol 2200 from Nippon Zeon, IR synthesized by Ziegler-Natta polymerization of isoprene in the presence of a Ti-based catalytic system
(2) IR synthesized by Ziegler-Natta polymerization of isoprene in the presence of a Nd-based catalytic system
(3) N234
(4) Silica, Zeosil 1165 MP, Rhodia, in the form of microbeads
(5) TESPT (Si69, Degussa)
(6) 2,4,6-Trimethyl-3-(2-(2-oxoimidazolidin-1-yl)ethoxy)benzonitrile oxide
(7) N-Cyclohexyl-2-benzothiazolesulfenamide (Santocure CBS, Flexys)

TABLE 2

| Properties in the cured state | C1 | C1-R | C2 | C2-R |
|---|---|---|---|---|
| Tanδₘₐₓ 23° C. | 55 | 100 | 67 | 100 |
| Tanδₘₐₓ 60° C. | 59 | 100 | 75 | 100 |

1. A rubber composition based at least on a reinforcing filler comprising a reinforcing inorganic filler and on a coupling agent,
the rubber composition including a 1,3-dipolar compound comprising a group Q and a group A connected together by a group B, in which Q comprises a dipole containing at least one nitrogen atom, A comprises an associative group comprising at least one nitrogen atom and B is an atom or a group of atoms forming a bond between Q and A, wherein
the diene elastomer is obtained by stereospecific polymerization of at least one 1,3-diene by means of a Ziegler-Natta catalytic system and contains less than 150 ppm of the element neodymium.

2. A rubber composition according to claim 1, in which the diene elastomer is obtained by stereospecific polymerization of a conjugated diene in the presence of a titanium-based Zieger-Natta catalytic system.

3. A rubber composition according to claim 1, in which the diene elastomer comprises from 100 to less than 1000 ppm of titanium element.

4. A rubber composition according to claim 1, in which the diene elastomer contains more than 90% of cis-1,4-bonds.

5. A rubber composition according to claim 1, in which the 1,3-dipolar compound is pregrafted to the diene elastomer.

6. A rubber composition according to claim 1, in which the group A is selected from the group consisting of the imidazolidinyl, triazolyl, triazinyl, bis-ureyl and ureido-pyrimidyl groups.

7. A rubber composition according to claim 1, in which the group A corresponds to one of the following formulae (I) to (VI): 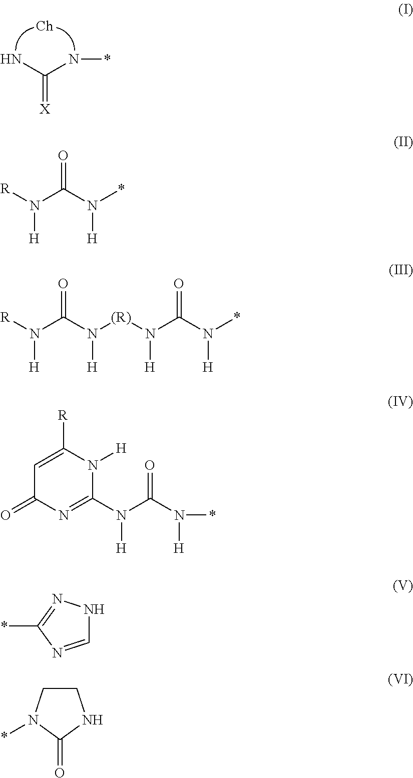
where:
Ch denotes a carbon chain which can optionally contain heteroatoms,
* represents a direct attachment to B,
R denotes a hydrocarbon group which can optionally contain heteroatoms,
X denotes an oxygen or sulfur atom or an NH group, preferably an oxygen atom.

8. A rubber composition according to claim 1, in which the 1,3-dipolar compound is selected from the group consisting of nitrile oxides, nitrones and nitrile imines.

9. A rubber composition according to claim 1, in which Q contains a —C≡N→O unit

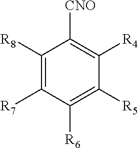

10. A rubber composition according to claim 9, in which Q denotes a unit corresponding to the formula (VII): 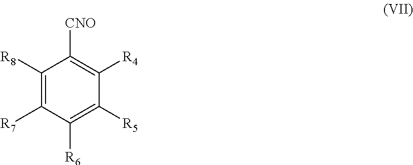
in which:
four of the five symbols R₄ to R₈, which are identical or different, are each an atom or a group of atoms, and the fifth symbol denotes a direct attachment to B, and
in which R₄, R₆ and R₈ are each an alkyl group of 1 to 6 carbon atoms.

11. A rubber composition according to claim 10, in which R₄, R₆ and R₈ are each a methyl or ethyl.

12. A rubber composition according to claim 10, in which Q denotes the unit of formula (VII) and B represents a unit chosen from —(CH₁)_{y1}—, —[NH—(CH₂)_{y2}]ₓ₁— and —[O—(CH₂)_{y3}]ₓ₂—, y₁, y₂ and y₃ independently representing an integer ranging from 1 to 6, and x₁ and x₂ independently representing an integer ranging from 1 to 4.

13. A rubber composition according to claim 1, in which the 1,3-dipolar compound is one of the compounds of formulae (VIII) to (XIII):

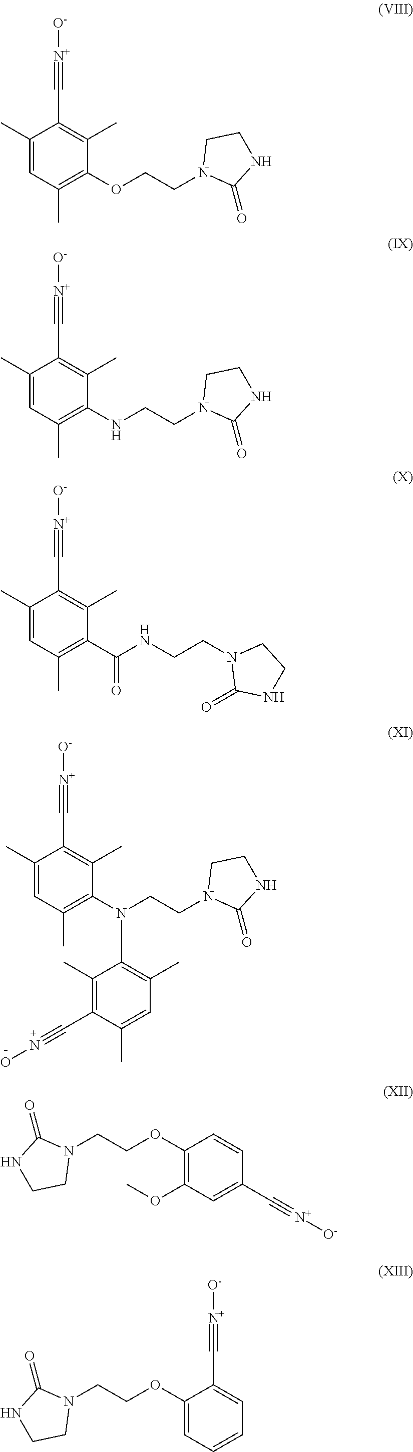

14. A rubber composition according to claim 1, in which Q contains a —C═N→O— unit corresponding to the formula (XIV) or (XV): 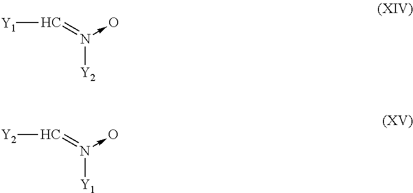
where:
Y₁ is an aliphatic group or a group containing from 6 to 20 carbon atoms and comprising an aromatic unit,
and Y₂ is an aliphatic group, or a group comprising an aromatic unit, Y₂ comprising a direct attachment to B.

15. A rubber composition according to claim 14, in which the 1,3-dipolar compound is one of the 1,3-dipolar compounds of formulae (XVI) to (XX): 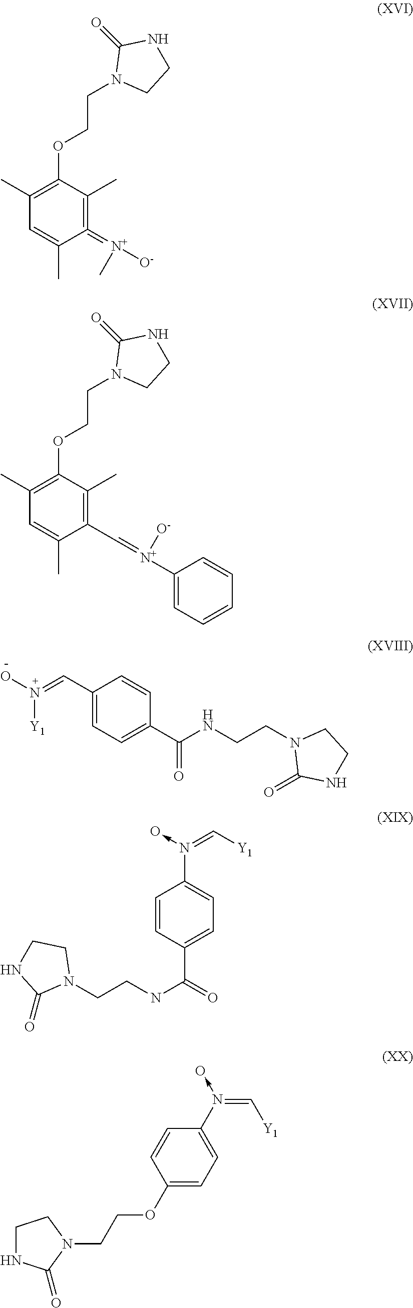
Y₁ being an aliphatic group or a group containing from 6 to 20 carbon atoms and comprising an aromatic unit.

16. A rubber composition according to claim 1, in which the content of 1,3-dipolar compound varies from 0.01 to 50 molar equivalents of group A per 100 mol of monomer units constituting the diene elastomer.

17. A rubber composition according to claim 1, in which the reinforcing inorganic filler represents more than 50% by weight of the reinforcing filler.

18. A method of making a rubber composition comprising the steps of combining a 1,3-dipolar compound with a reinforcing filler comprising a reinforcing inorganic filler and on a coupling agent,
the 1,3-dipolar compound comprising a group Q and a group A connected together by a group B, in which Q comprises a dipole containing at least one nitrogen atom, A comprises an associative group comprising at least one nitrogen atom and B is an atom or a group of atoms forming a bond between Q and A, wherein
the diene elastomer is obtained by stereospecific polymerization of at least one 1,3-diene by means of a Ziegler-Natta catalytic system and contains less than 150 ppm of the element neodymium.
